(19) United States
(12) Patent Application Publication
(10) Pub. No.: US 2016/0361710 A1
(43) Pub. Date: Dec. 15, 2016

(54) Reversibility of Copper-Manganese Binary Spinel Structure under Reduction-Oxidation Conditions

(71) Applicant: Clean Diesel Technologies, Inc., Oxnard, CA (US)

(72) Inventors: Zahra Nazarpoor, Camarillo, CA (US); Stephen J. Golden, Santa Barbra, CA (US)

(21) Appl. No.: 15/182,306

(22) Filed: Jun. 14, 2016

Related U.S. Application Data
(60) Provisional application No. 62/175,956, filed on Jun. 15, 2015.

(51) Int. Cl. B01J 23/889; B01D 53/94; B01J 35/02; C01G 45/12; B01J 23/00

(52) U.S. Cl. CPC B01J 23/8892; C01G 45/1221; B01J 23/005; B01J 35/026; B01D 53/945; B01D 2255/405

(57) ABSTRACT

The present disclosure describes zero-platinum group metals (ZPGM) material compositions including binary Cu—Mn spinel oxide powders that possess stable reduction/oxidation (redox) reversibility useful for TWC and oxygen storage material (OSM) applications. The redox behavior of Cu—Mn spinel oxide powders is analyzed under oxidation-reduction environments to determine spinel structure stability. The XRD, TPR and XPS analyses confirm the redox stability and reversibility of the Cu—Mn spinel oxide.

### CROSS-REFERENCE TO RELATED APPLICATIONS

This application claims priority to U.S. Provisional Application Ser. No. 62/175,956, filed Jun. 15, 2015, which is hereby incorporated by reference.

### BACKGROUND

Field of the Disclosure

This disclosure relates generally to zero-PGM (ZPGM) catalyst materials, and more particularly, to reversible redox properties of spinel-based oxide materials for use in a plurality of catalyst applications.

Background Information

Conventional gasoline exhaust systems employ three-way catalysts (TWC) technology and are referred to as TWC systems. TWC systems convert the toxic CO, HC and NOₓ into less harmful pollutants. Typically, TWC systems include a substrate structure upon which a layer of supporting and sometimes promoting oxides are deposited. Catalysts, based on platinum group metals (PGM), are then deposited upon the supporting oxides. Conventional PGM materials include platinum (Pt), palladium (Pd), rhodium (Rh), iridium (Ir), or combinations thereof.

Although PGM catalyst materials are effective for toxic emission control and have been commercialized by the emissions control industry, PGM materials are scarce and expensive. This high cost remains a critical factor for widespread applications of PGM catalyst materials. As changes in the formulation of catalysts continue to increase the cost of TWC systems, the need for catalysts of significant catalytic performance has directed efforts toward the development of catalytic materials capable of providing the required synergies to achieve greater catalytic performance. Additionally, compliance with ever stricter environmental regulations and the need for lower manufacturing costs require new types of TWC systems. Therefore, there is a continuing need to provide TWC systems exhibiting catalytic properties substantially similar to or exceeding the catalytic properties exhibited by conventional TWC systems employing high PGM catalyst materials.

### SUMMARY

The present disclosure describes zero-platinum group metals (ZPGM) material compositions including binary spinel oxide powders to develop suitable ZPGM catalyst materials. Further, the present disclosure describes the reduction/oxidation (redox) reversibility of the aforementioned ZPGM catalyst materials. These ZPGM catalyst materials can be used for a variety of catalyst applications, such as, for example oxygen storage material (OSM) applications, and ZPGM and ultra-low loading synergized-PGM (SPGM) three-way catalyst (TWC) systems, amongst others.

In some embodiments, the ZPGM catalyst materials include binary spinel oxide compositions, which are synthesized using conventional synthesis methodologies to produce spinel oxide powders. In these embodiments, the binary spinel oxide composition is implemented as copper (Cu)-manganese (Mn) spinel oxide compositions. Further to these embodiments, the Cu—Mn spinel oxide is produced using a general formulation Cu_{X}Mn_{3-X}O₄ spinel in which X is a variable representing molar ratios within a range from about 0.01 to about 2.99. In an example, X takes a value of about 1.0 for a stoichiometric CuMn₂O₄ spinel oxide powder.

In some embodiments, the redox behavior of the Cu—Mn spinel oxide powder is analyzed within oxidation-reduction environments to determine the redox property of the Cu—Mn spinel oxide powder. In these embodiments, functional testing and chemical characterization of Cu—Mn spinel powder are conducted to assess the structure stability of the spinel phase to redox reactions. Further to these embodiments, the Cu—Mn spinel powders are characterized after the oxidation-reduction reactions employing XRD, XPS, and TPR analyses.

The results confirm the significant redox reversibility of the Cu—Mn spinel oxide. In other words, the Cu—Mn spinel oxide, which is free of PGM and rare-earth (RE) metals, exhibits an improved redox property that can enable catalyst materials in bulk powder format for the development of a plurality of TWC systems and other catalyst applications.

In one aspect, the present invention provides a zero-platinum group metal catalytic composition comprising a binary Cu—Mn spinel of the formula CuₓMn₃₋ₓO₄, wherein X is a number from 0.01 to 2.99, and wherein the composition is reducible to form metal Cu and MnO, and then oxidizable to form said binary Cu—Mn spinel. In a preferred embodiment, the catalytic composition the binary Cu—Mn spinel is CuMn₂O₄.

In one embodiment, a concentration of Cu¹⁺ in the composition is greater than that of Cu²⁺ when the binary Cu—Mn spinel is in a reduced state.

In a preferred embodiment, the composition is in the form of a powder.

In some embodiments, the binary Cu—Mn spinel of the composition exhibits a crystalline size of about 26 nm following reduction.

In one embodiment, the binary Cu—Mn spinel has been reduced to form metal Cu and MnO.

In one aspect of the invention, the catalytic composition may be used in a catalytic converter.

Another aspect of the invention is directed to a method of removing pollutants from a gas stream comprising:

a) contacting an exhaust stream comprising one or more of NOx, CO, or HC with a catalytic composition comprising a binary Cu—Mn spinel of the formula CuₓMn₃₋ₓO₄, wherein X is a number from 0.01 to 2.99, and wherein the step of contacting results in a reduction of one or more of NOx, CO, or HC in the exhaust stream, and in a reduction of the Cu—Mn spinel to Cu metal and MnO; and

b) oxidizing the catalytic composition following step b) to form a binary Cu—Mn spinel of the formula CuₓMn₃₋ₓO₄.

In one embodiment, step a) is carried out a temperature from about 130° C. to 335° C., and in particular, at a temperature that is about 225° C. to 230° C.

In one embodiment, the method may include a step c) in which steps a) and b) are repeated at least once. In some embodiments, the catalytic composition has been subjected at least once to steps a) and b), and exhibits a crystalline size of about 26 nm.

Numerous other aspects, features, and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a graphical representation illustrating a powder X-ray diffraction (XRD) phase analysis for a copper (Cu)-manganese (Mn) spinel oxide, according to an embodiment.

FIG. 2 is a graphical representation illustrating a reduction and reduction-oxidation (redox) methodology to determine the redox property of a Cu—Mn spinel oxide, according to an embodiment.

FIG. 3 is a graphical representation illustrating an XRD phase analysis of a Cu—Mn spinel oxide powder after a full reduction condition process, according to an embodiment.

FIG. 4 is a graphical representation illustrating an XRD phase analysis of a Cu—Mn spinel oxide powder after a reduction-oxidation condition process, according to an embodiment.

FIG. 5 is a graphical representation illustrating results from a hydrogen temperature-programmed reduction (H₂-TPR) test of a Cu—Mn spinel powder, according to an embodiment.

FIG. 6 is a graphical representation illustrating a redox reversibility behavior of Cu cations within a Cu—Mn spinel powder characterized at various redox stages of the Cu—Mn spinel, employing X-ray photoelectron spectroscopy (XPS) analysis, according to an embodiment.

### DETAILED DESCRIPTION

The present disclosure is described herein in detail with reference to embodiments illustrated in the drawings, which form a part hereof. Other embodiments may be used and/or other modifications may be made without departing from the scope or spirit of the present disclosure. The illustrative embodiments described in the detailed description are not meant to be limiting of the subject matter presented.

Definitions

As used here, the following terms have the following definitions:

“Calcination” refers to a thermal treatment process applied to solid materials, in presence of air, to bring about a thermal decomposition, phase transition, or removal of a volatile fraction at temperatures below the melting point of the solid materials.

“Catalyst” refers to one or more materials that may be of use in the conversion of one or more other materials.

“Lattice matching” refers to a matching of a unit cell of an unknown material against a database of known materials represented by their respective standard unit cells to determine the unknown materials lattice parameters and identify the unknown material.

“Lattice parameter or Lattice constant” refers to the physical dimension of unit cells in a crystal lattice. Lattices in three dimensions have three lattice constants, referred to as a, b, and c. However, in the special case of cubic crystal structures, all of the constants are equal and only referred to a.

“Platinum group metals (PGM)” refers to platinum, palladium, ruthenium, iridium, osmium, and rhodium.

“Spinel” refers to any minerals of the general formulation AB₂O₄ where the A ion and B ion are each selected from mineral oxides, such as, for example magnesium, iron, zinc, manganese, aluminum, chromium, titanium, cobalt, nickel, or copper, amongst others.

“Temperature-programmed reduction (TPR)” refers to a technique for the characterization of solid materials often used in the field of heterogeneous catalysis to find the most efficient reduction conditions, in which a catalyst is subjected to a programmed temperature rise, while a reducing gas mixture is flowed over it.

“Three-way catalyst (TWC)” refers to a catalyst that performs the three simultaneous tasks of reduction of nitrogen oxides to nitrogen and oxygen, oxidation of carbon monoxide to carbon dioxide, and oxidation of unburnt hydrocarbons to carbon dioxide and water.

“X-ray diffraction (XRD) analysis” refers to analytical technique for identifying crystalline material structures, including atomic arrangement, crystalline size, and imperfections in order to identify unknown crystalline materials (e.g., minerals, inorganic compounds).

“X-ray photoelectron spectroscopy (XPS) analysis” refers to a surface-sensitive quantitative spectroscopy technique that measures the elemental composition at the parts per thousand range, empirical formula, chemical state, and electronic state of the elements that exist within a material.

### DESCRIPTION OF THE DISCLOSURE

The present disclosure describes zero-platinum group metals (ZPGM) material compositions including binary spinel oxide powders to develop suitable ZPGM catalyst materials. Further, the present disclosure describes a reduction-oxidation (redox) stability and reversibility of the aforementioned ZPGM catalyst materials. These ZPGM catalyst materials can be used for a variety of catalyst applications, such as, for example oxygen storage material (OSM) applications, and ZPGM and ultra-low loading synergized-PGM (SPGM) three-way catalyst (TWC) systems, amongst others.

ZPGM Catalyst Material Composition and Preparation

In some embodiments, the ZPGM catalyst materials include binary spinel oxide compositions, which are synthesized using conventional synthesis methodologies to produce spinel oxide powders. In these embodiments, the binary spinel oxide composition is implemented as copper (Cu)-manganese (Mn) spinel oxide compositions. Further to these embodiments, the Cu—Mn spinel oxide is produced using a general formulation Cu_{X}Mn_{3-X}O₄ spinel in which X is a variable representing molar ratios within a range from about 0.01 to about 2.99. In an example, X takes a value of about 1.0 for a stoichiometric CuMn₂O₄ spinel oxide powder. In these embodiments, bulk powder of CuMn₂O₄ spinel is produced as described in U.S. patent application Ser. No. 13/891,617. Further to these embodiments, bulk powder Cu—Mn spinel is calcined at a plurality of temperatures within a range from about 600° C. to about 1000° C.

X-ray Diffraction Analysis for CuMn₂O₄ Spinel Phase Formation

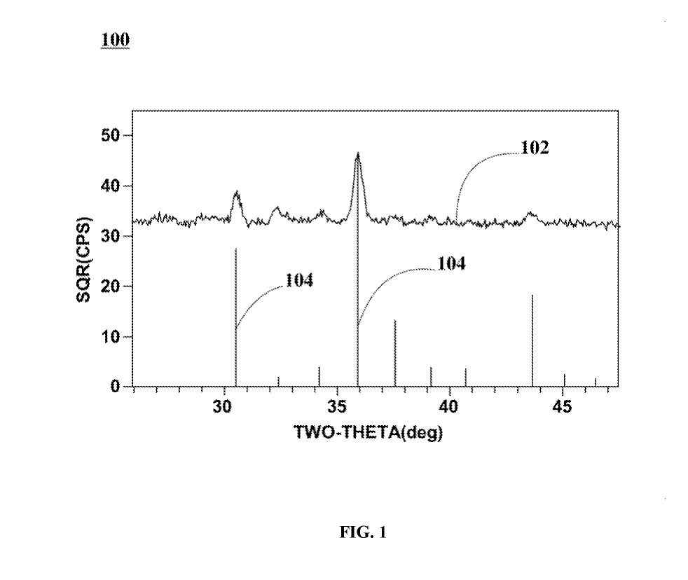

FIG. 1 is a graphical representation illustrating a powder X-ray diffraction (XRD) phase analysis for a copper (Cu)-manganese (Mn) spinel oxide, according to an embodiment. In FIG. 1, XRD analysis 100 includes XRD spectrum 102 and spectral lines 104.

In some embodiments, XRD spectrum 102 illustrates diffraction peaks of bulk powder Cu—Mn spinel. In these embodiments, a single phase CuMn₂O₄ spinel is produced, as illustrated by spectral lines 104. Further to these embodiments, no additional diffraction peaks or no secondary phase could be identified, and only CuMn₂O₄ spinel oxide is observed after calcination step at suitable temperatures.

In FIG. 1, XRD analysis 100 indicates that the spinel structure of bulk powder CuMn₂O₄ spinet exhibits a cubic symmetry (e.g., a=b=c and α=β=γ), where the lattice parameter “a” is about 8.28 Å.

Redox Behavior of Cu—Mn Spinel Oxide

In some embodiments, the Cu—Mn spinel oxide powder is subjected to a redox reaction to determine the phase stability of the aforementioned Cu—Mn binary spinel oxide after the redox reaction.

Reversibility and Stability Analysis of CuMn₂O₄ Spinel After Redox Condition

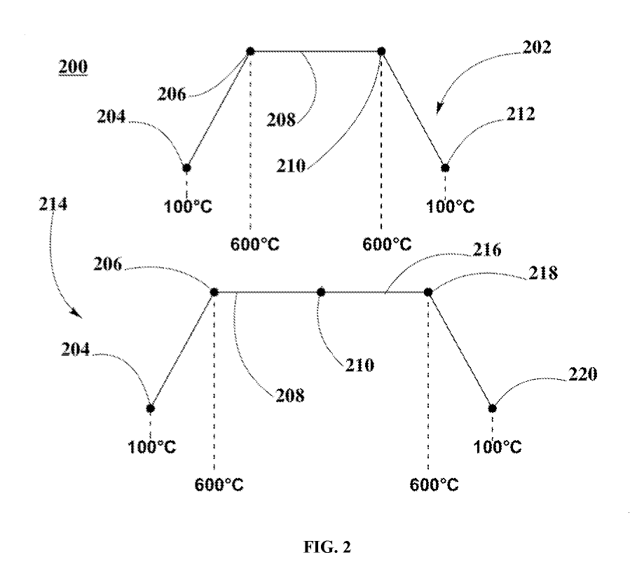

FIG. 2 is a graphical representation illustrating a reduction and reduction-oxidation (redox) methodology to determine the redox property of a Cu—Mn spinel oxide, according to an embodiment. In FIG. 2, process methodology 200 includes full reduction reaction process 202 and redox reaction process 214. Full reduction reaction process 202 further includes point 204, point 206, isothermal reduction reaction 208, point 210, and point 212. Redox condition process 214 further includes point 204, point 206, isothermal reduction reaction 208, point 210, isothermal oxidation reaction 216, point 218, and point 220.

In some embodiments and referring to full reduction reaction process 202, points 204 and 206 illustrate a nitrogen (N₂) feeding gas, at an initial temperature of about 100° C., into the flow reactor until the reactor temperature, increased at a ramping rate of 10° C./min, reaches about 600° C. at point 206. In these embodiments, isothermal reduction reaction 208 illustrates, starting at point 206, the reducing feed gas having about 0.5% CO at an isothermal temperature of about 600° C. for about 2 hours, at point 210. Further to these embodiments, points 210 and 212 illustrate the beginning and ending of a cooling step wherein the flow reactor is cooled from about 600° C. to about 100° C. while continuously purging N₂ gas into the reactor to retain the reduction state of the Cu—Mn spinet oxide powder. Still further to these embodiments, the Cu—Mn spinel oxide powder after complete reduction is characterized by means of an XRD analysis to detect the phase changes as a result of full reduction condition process.

In other embodiments, reduction-oxidation reaction process 214 is carried out, after the full reduction reaction process 202 described above, at point 210, isothermal oxidation reaction 216 illustrates feeding of an oxidation gas at isothermal condition having about 0.5% O₂ at about 600° C. for about 2 hours, until point 218. In these embodiments, points 218 and 220 illustrate the initial and final of a cooling step wherein the flow reactor is cooled from about 600° C. to about 100° C. while purging inner N₂ gas into the reactor to complete the reduction-oxidation condition process of the Cu—Mn spinel oxide powder. Further to these embodiments, the Cu—Mn spinel oxide powder is characterized by means of an XRD analysis to detect the phases formed as a result of the complete reduction-oxidation cycle.

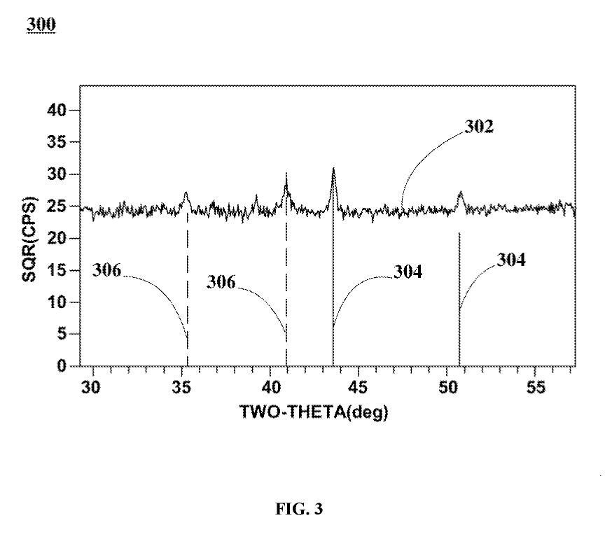

FIG. 3 is a graphical representation illustrating an XRD phase analysis of a Cu—Mn spinel oxide powder after a full reduction condition process, according to an embodiment. In FIG. 3, XRD analysis 300 includes XRD spectrum 302, spectral lines 304 (solid lines), and spectral lines 306 (dash lines).

In some embodiments, XRD spectrum 302 illustrates diffraction peaks products formed after full reduction of a Cu—Mn spinel oxide powder. In these embodiments, spectral lines 304 illustrates a phase of Cu metal produced after full reduction of the Cu—Mn spinel oxide powder. Further to these embodiments, spectral lines 306 illustrates a separate phase of MnO produced after full reduction of the Cu—Mn spinel oxide powder.

In some embodiments and referring to FIG. 3, XRD analysis 300 indicates that under reducing conditions the structure of bulk powder CuMn₂O₄ spinel decomposes to Cu metal and MnO and exhibits phases of cubic symmetry (e.g., a=b=c and α=β=γ), where the lattice parameters “a” are about 3.615 Å and about 4.444 Å for Cu metal and MnO, respectively. In these embodiments, the Cu—Mn binary spinel oxide is unstable under reduction conditions and decomposes to Cu metal and MnO.

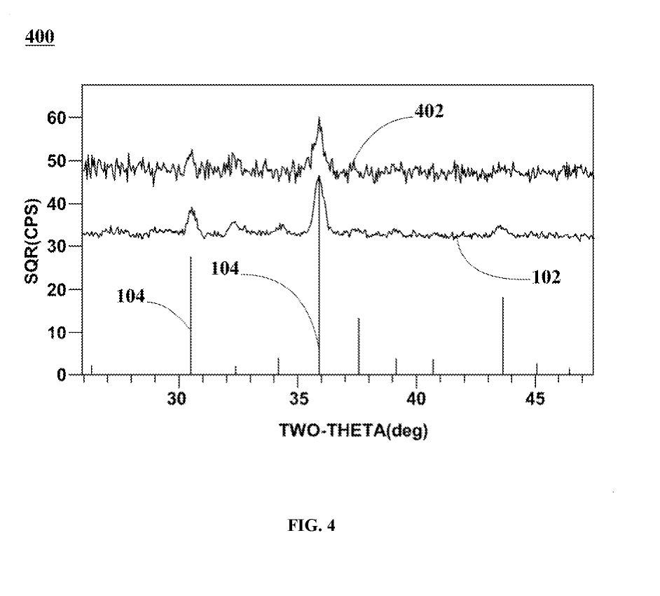

FIG. 4 is a graphical representation illustrating an XRD phase analysis of a Cu—Mn spinel oxide powder after a reduction-oxidation condition process, according to an embodiment. In FIG. 4, XRD analysis 400 includes XRD spectrum 402, XRD spectrum 102, and spectral lines 104. In FIG. 4, elements having substantially similar element numbers from previous figures function in a substantially similar manner.

In some embodiments, XRD spectrum 402 illustrates diffraction peaks of spinel phases produced after reduction-oxidation of a Cu—Mn spinel oxide powder. In these embodiments and after the reduction-oxidation condition process, the pure CuMn₂O₄ spinel oxide phase is retained, as illustrated by spectral lines 104, which are the same spectral lines of the pure Cu—Mn spinel oxide powder before reduction, as illustrated by XRD spectrum 102. Further to these embodiments, the probing of the CuMn₂O₄ spinel oxide powder under reduction-oxidation condition process confirms that Cu—Mn spinel oxide powder is full reversible after reduction-oxidation reactions.

In some embodiments and referring to FIG. 4, XRD analysis 400 indicates that the spinel structure of bulk powder CuMn₂O₄ spinel exhibits a cubic symmetry (e.g., a=b=c and α=β=γ), where the lattice parameter “a” is about 8.28 Å. Additionally, the crystallite size of bulk powder CuMn₂O₄ spinel is about 26 nm.

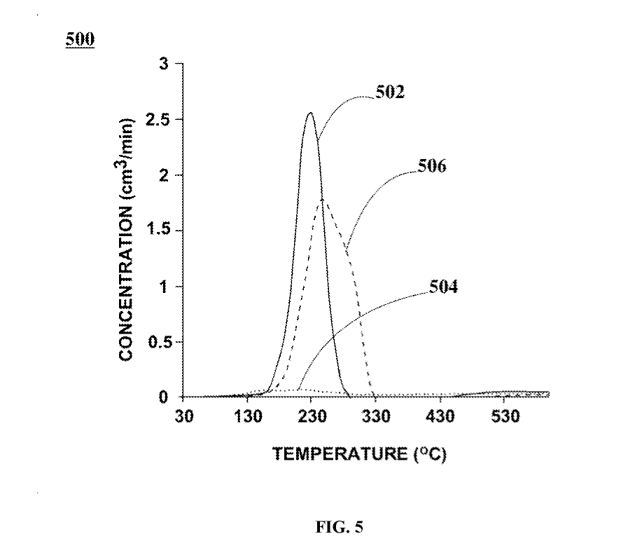

FIG. 5 is a graphical representation illustrating results from a hydrogen temperature-programmed reduction (H₂-TPR) test of a Cu—Mn spinel powder, according to an embodiment. In FIG. 5, H₂-TPR profile 500 includes TPR spectrum 502, TPR spectrum 504, and TPR spectrum 506, in which each spectrum represents associated hydrogen consumption at a given temperatures for Cu—Mn spinel powders at different conditions.

In some embodiments, H₂-TPR testing is performed employing a reducing gas mixture of about 10% H₂ diluted in argon (Ar). In these embodiments, the Cu—Mn spinel oxide powder samples at various stages of redox reaction (e.g., fresh, after full reduction reaction and after reduction-oxidation reaction cycle) is heated up at a temperature programmed ramp of 10° C./min up to a temperature of about 950° C., with a dwell time of about 3 minutes. Further to these embodiments, the detailed reduction reaction and redox reaction conditions are described in FIG. 2. Still further to these embodiments, TPR spectrum 502 illustrates the result of the H₂ consumption per gram of fresh Cu—Mn spinel as a function of temperature. In these embodiments, TPR spectrum 504 illustrates the result of the H₂ consumption per gram of full reduced Cu—Mn spinel after reduction reaction as a function of temperature and described in FIG. 2. Further to these embodiments, TPR spectrum 506 illustrates the result of the H₂ consumption per gram of Cu—Mn after reduction-oxidation cycle as a function of temperature and described in FIG. 2.

In some embodiments, TPR spectrum 502 confirms that fresh Cu—Mn spinel oxide powder exhibits full reduction of the spinel oxide to Cu metal and MnO at a temperature of about 229° C. during H₂-TPR testing. In these embodiments, TPR spectrum 504 confirms that, at the TPR of the full reduced spinel oxide powder, no reduction peak is observed during H₂-TPR testing. Further to these embodiments, TPR spectrum 506 confirms that spinel after reduction-oxidation exhibits full reduction of the spinel oxide to Cu metal and MnO at a temperature of about 248° C. that is substantially similar to fresh Cu—Mn spinel illustrated in TPR spectrum 502.

In some embodiments, the integration of the area under the associated curve provides the total hydrogen consumption (mL/g spinel) that occurs during H₂-TPR testing. In these embodiments, H₂ consumption of TPR spectrum 502 is about 141.9 mL/g, for TPR spectrum 504 is about 7.1 mL/g, and for TPR spectrum 506 is about 149.1 mL/g. Further to these embodiments, the H₂ consumption of fresh spinel and spinel after redox reaction exhibit very close numbers, which suggests that the Cu—Mn spinel structure is reversible to redox reactions.

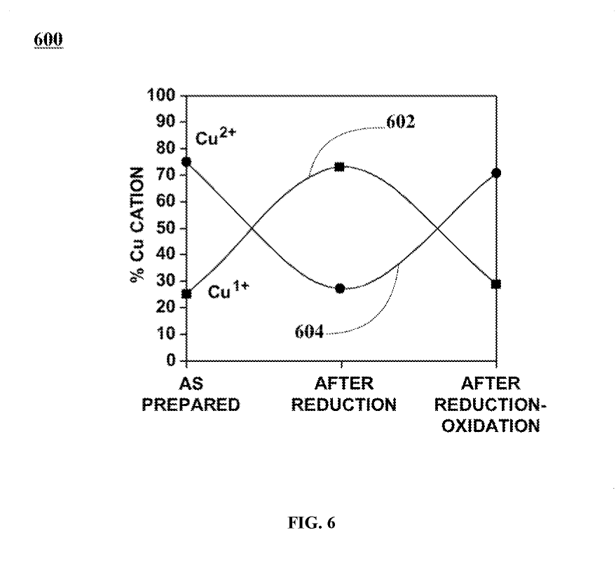

FIG. 6 is a graphical representation illustrating a redox reversibility behavior of Cu cations within a Cu—Mn spinel powder characterized at various redox stages of the Cu—Mn spinel, employing X-ray photoelectron spectroscopy (XPS) analysis, according to an embodiment. In FIG. 6, redox behavior graph 600 includes Cu⁻¹ reversibility curve 602 and Cu²⁺ reversibility curve 604.

In some embodiments, reversibility curves 602 and 604 illustrate that Cu²⁺ cations are reduced to Cu¹⁺ cations and are then further re-oxidized back to Cu²⁺ cations. In these embodiments, in a fresh Cu—Mn spinel the Cu²⁺ concentration is higher than the Cu¹⁺ concentration, therefore majority of Cu cations in spinel oxide is in form of Cu²⁺. Further to these embodiments and after full reduction reaction, the Cu¹⁺ concentration is higher than the Cu²⁺ concentration, thereby indicating that majority of the Cu cations are reduced to Cu¹⁺. Still further to these embodiments and after re-oxidation (complete redox cycle) of the spinel oxide powder, the Cu—Mn spinel oxide powder exhibits again a higher concentration of Cu²⁺ than Cu¹⁺ concentration, thereby indicating re-oxidation of Cu¹⁺ to Cu²⁺. In these embodiments, the oxidation state of Cu within the Cu—Mn spinel oxide powder resulting from the XPS analysis confirms that the Cu—Mn spinel exhibits a reversible oxidation state property.

In summary, based on the XRD, TPR, and XPS analyses, the Cu—Mn spinel oxide powder decomposes to Cu metal and MnO during full reduction cycle and retains its spinel structure and property after re-oxidation (redox cycle). Further, the consumption of H₂ during the H₂-TPR testing of the Cu—Mn spinel oxide powder confirms the reversible redox property of the Cu—Mn spinel after the reduction-oxidation cycle. Still further, the reversible redox property of the Cu—Mn spinel oxide powder is confirmed by the reproduction of Cu²⁺ cations resulting from the XPS analysis after the reduction-oxidation condition process. The XRD, TPR, and XPS analyses verify the significant oxidation-reduction stability of the Cu—Mn spinel oxide. As such, the Cu—Mn spinel oxide, free of PGM and rare-earth metals, can enable catalyst materials in bulk powder format for the development of a plurality of TWC systems and other catalyst applications.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A zero-platinum group metal catalytic composition comprising a binary Cu—Mn spinel of the formula CuₓMn₃₋ₓO₄, wherein X is a number from 0.01 to 2.99, and wherein the composition is reducible to form metal Cu and MnO, and then oxidizable to form said binary Cu—Mn spinel.

2. The catalytic composition of claim 1, wherein the binary Cu—Mn spinel is CuMn₂O₄.

3. The catalytic composition of claim 1, wherein a concentration of Cu¹⁺ in the composition is greater than that of Cu ²⁺ when the binary Cu—Mn spinel is in a reduced state.

4. The catalytic composition of claim 1, wherein the composition is in the form of a powder.

5. The catalytic composition of claim 1, wherein following reduction, the binary Cu—Mn spinel exhibits a crystalline size of about 26 nm.

6. The catalytic composition of claim 1, wherein the binary Cu—Mn spinel has been reduced to form metal Cu and MnO.

7. A catalytic converter comprising the catalytic composition of claim 1.

8. A powder comprising a binary Cu—Mn spinel of the formula CuₓMn₃₋ₓO₄, wherein X is a number from 0.01 to 2.99, and wherein the binary Cu—Mn spinel has been reduced to form metal Cu and MnO.

9. The powder of claim 8, wherein the binary Cu—Mn spinel is CuMn₂O₄.

10. A method of removing pollutants from a gas stream comprising:
a) contacting an exhaust stream comprising one or more of NOx, CO, or HC with a catalytic composition comprising a binary Cu—Mn spinel of the formula CuₓMn₃₋ₓO₄, wherein X is a number from 0.01 to 2.99, and wherein the step of contacting results in a reduction of one or more of NOx, CO, or HC in the exhaust stream, and in a reduction of the Cu—Mn spinel to Cu metal and MnO; and
b) oxidizing the catalytic composition following step b) to form a binary Cu—Mn spinel of the formula CuₓMn₃₋ₓO₄.

11. The method of claim 10, wherein step a) is carried out a temperature from about 130° C. to 335° C.

12. The method of claim 10, wherein step a) is carried out a temperature that is about 225° C. to 230° C.

13. The method of claim 10, further comprising a step c) of repeating steps a) and b).

14. The method of claim 10, wherein the catalytic composition has been subjected at least once to steps a) and b), and exhibits a crystalline size of about 26 nm.

15. The method of claim 10, wherein the binary Cu—Mn spinel is CuMn₂O₄.

16. The method of claim 10, wherein a concentration of Cu¹⁺ in the binary Cu—Mn spinel is greater than that of Cu²⁺ when the binary Cu—Mn spinel is in a reduced state.
